(19) United States
(12) Patent Application Publication
(10) Pub. No.: US 2020/0323414 A1
(43) Pub. Date: Oct. 15, 2020

(54) ECO-FRIENDLY SPONGE CLOTH MECHANICALLY BONDED TO AN ABRASIVE FABRIC

(71) Applicant: Charles Justin Davies, Rutherfordton, NC (US)

(72) Inventor: Charles Justin Davies, Rutherfordton, NC (US)

(21) Appl. No.: 16/784,921

(22) Filed: Feb. 7, 2020

Related U.S. Application Data
(60) Provisional application No. 62/831,887, filed on Apr. 10, 2019.

(51) Int. Cl. A47L 13/16; C08L 1/02

(52) U.S. Cl. CPC A47L 13/16; C08L 2201/06; C08L 1/02

(57) ABSTRACT

A cleaning tool is provided. The cleaning tool integrates a Swedish sponge clothe material and a woven fabric material joined through a durable attachment.

### CROSS-REFERENCE TO RELATED APPLICATION

This application claims the benefit of priority of U.S. provisional application No. 62/831,887, filed 10 Apr. 2019, the contents of which are herein incorporated by reference.

### BACKGROUND OF THE INVENTION

The present invention relates to cleaning tools and, more particularly, to an eco-friendly sponge cloth mechanically bonded to an abrasive fabric.

As of right now, there is no product on the market that contains the eco-friendliness of the Swedish (European) sponge cloth combined with the non-scratch scrubby coated fabric. Current cleaning devices that have a sponge type material and an abrasive material are made primarily of synthetic materials, which is not a sustainable option. Current wiping and scrubbing devices for residential and commercial cleaning do not have the eco-friendly compositions.

Given the growing demand in the US market for more sustainable cleaning solutions, the present invention fills the need in providing an eco-friendly sponge cloth with a mechanically joined scrubbing material. Thereby, the present invention offers the wiping and scrubbing component while simultaneously being environmentally friendly. All of the compositions are cellulose and cotton minus some eco-friendly coating. The present invention is a manufacturing item that bonds a Swedish (European) sponge cloth to an abrasive fabric, creating a versatile yet eco-friendly cleaning device.

### SUMMARY OF THE INVENTION

In one aspect of the present invention, a cleaning tool including the following: a Swedish sponge clothe material; and a woven fabric material joined to the Swedish sponge clothe material by an attachment.

In another aspect of the present invention, the cleaning tool includes the following: a Swedish sponge clothe material, wherein the Swedish sponge clothe material comprises biodegradable cellulose material and cotton fiber, wherein the Swedish sponge clothe material is adapted to last six months and absorb sixteen times its weight in liquid, wherein the Swedish sponge clothe material is adapted to decompose in a compost in less than five weeks; a woven fabric material joined to the Swedish sponge clothe material by stitching, wherein the Swedish sponge clothe material and the woven fabric material defined a flat geometric shape; and a non-toxic coating on the woven fabric material.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention;

FIG. 2 is a top plan view of an exemplary embodiment of the present invention;

FIG. 3 is a perspective view of an exemplary embodiment of the present invention, shown in use; and

FIG. 4 is a section view of an exemplary embodiment of the present invention, shown in use in a mop configuration.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a cleaning tool incorporating a Swedish sponge clothe material and a woven fabric material joined through a durable attachment.

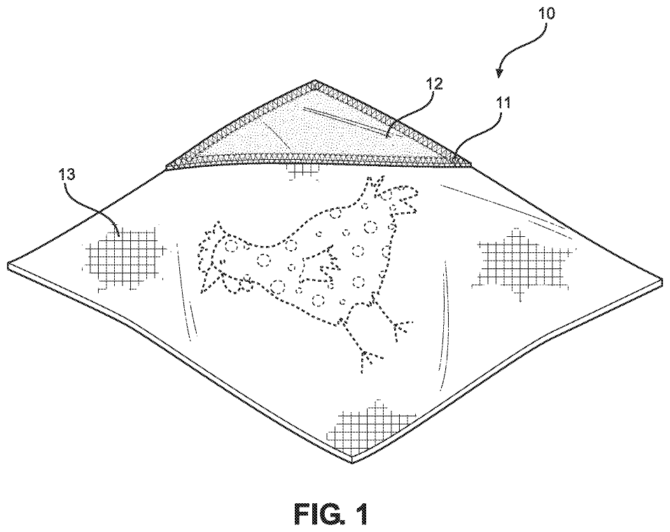

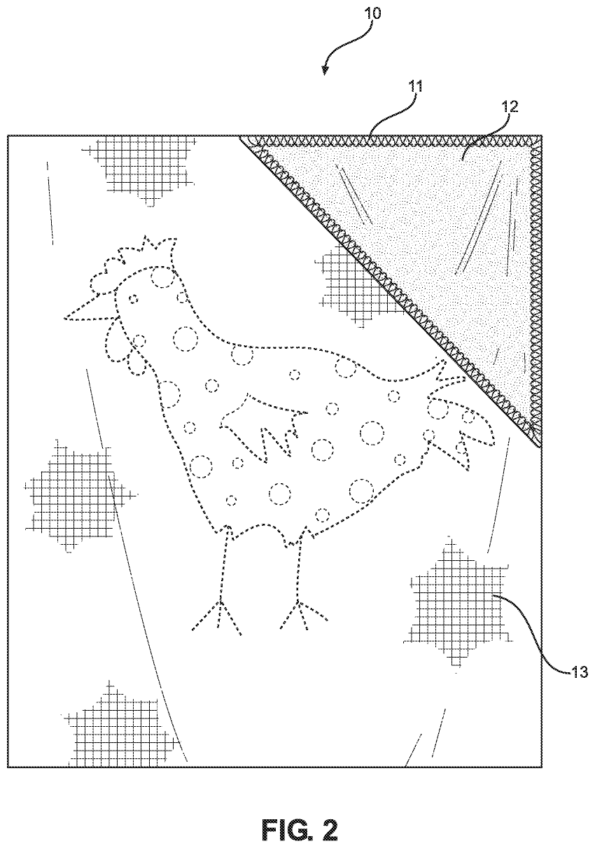

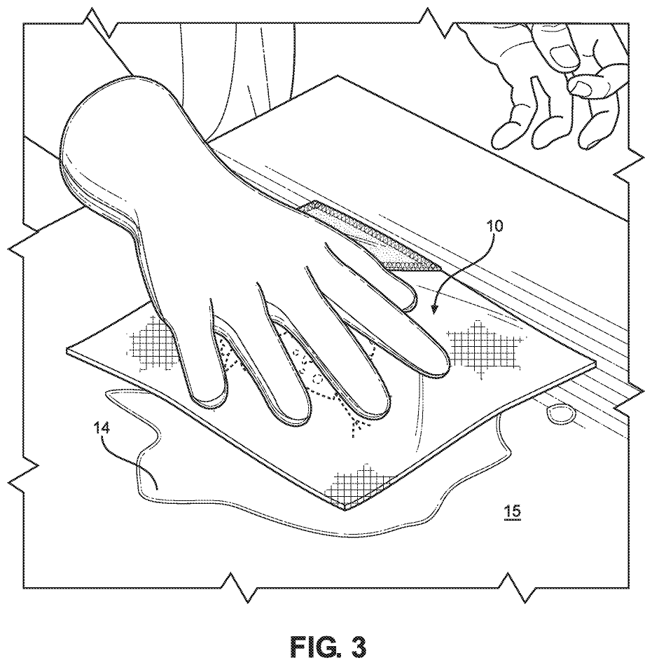

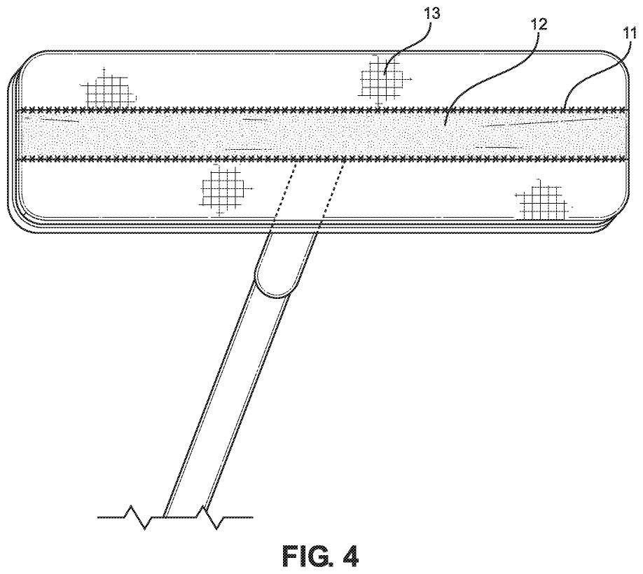

Referring to FIGS. 1 through 4, the present invention may include a cleaning tool 10 including a Swedish sponge clothe material 13 and a woven fabric material 12 joined through an attachment 11.

The Swedish sponge clothe material 13 includes natural/biodegradable material (cellulose and cotton fibers). The woven fabric material 12 may include cotton and/or other biodegradable material with a non-toxic coating. The attachment 11 may be the result of sewing or other joining operation to combine the Swedish sponge clothe material 13 and the woven fabric material 12, including but not limited to adhesives.

The Swedish sponge clothe material 13 is adapted to last six months under normal household usage and absorb sixteen times its weight in liquid 14 which equates to six paper towels and a ⅓ cup of water. Because of its material composition, the Swedish sponge clothe material 13 is adapted to decompose in a compost in less than five weeks. The woven fabric material 12 may be composed of cotton and a water-based coating. While this product has the feeling of Velcro™, it does not scratch most common household materials.

The combination of the Swedish sponge clothe material 13 and the woven fabric material 12 embodied in the present invention allows the consumer to soak and wipe up spills 14 like a sponge as well as scrub and remove hard stuck on dirt without scratching most common household surfaces 15. And, the novel combination decomposes under normal environmental conditions.

A method of using the present invention may include the following. The cleaning tool 10 disclosed above may be provided. A user would utilize the cleaning tool 10 like any other household sponge or clothe but with the enhanced capabilities of removing hard stuck on dirt without scratching and with the added function of soaking and removing dirt from any surface 15.

It should be understood, of course, that the foregoing relates to exemplary embodiments of the invention and that modifications may be made without departing from the spirit and scope of the invention as set forth in the following claims.

What is claimed is:

1. A cleaning tool, comprising:
a Swedish sponge clothe material; and
a woven fabric material joined to the Swedish sponge clothe material by an attachment.

2. The cleaning tool of claim 1, wherein the Swedish sponge clothe material and the woven fabric material defined a flat geometric shape.

3. The cleaning tool of claim 2, wherein the flat geometric shape is a rectangle, and wherein the woven fabric material defines only one corner of the rectangle.

4. The cleaning tool of claim 1, further comprising a non-toxic coating on the woven fabric material.

5. The cleaning tool of claim 1, wherein the woven fabric material is cotton.

6. The cleaning tool of claim 1, wherein the Swedish sponge clothe material comprises biodegradable cellulose material.

7. The cleaning tool of claim 6, wherein the Swedish sponge clothe material comprises biodegradable cotton fibers.

8. The cleaning tool of claim 1, wherein the Swedish sponge clothe material is adapted to last six months and absorb sixteen times its weight in liquid.

9. The cleaning tool of claim 1, wherein the Swedish sponge clothe material is adapted to decompose in a compost in less than five weeks.

10. The cleaning tool of claim 1, wherein the attachment is stitching.

11. The cleaning tool of claim 1, wherein the attachment is an adhesive.

12. A cleaning tool, comprising:
a Swedish sponge clothe material, wherein the Swedish sponge clothe material comprises biodegradable cellulose material and cotton fiber, wherein the Swedish sponge clothe material is adapted to last six months and absorb sixteen times its weight in liquid, wherein the Swedish sponge clothe material is adapted to decompose in a compost in less than five weeks;
a woven fabric material joined to the Swedish sponge clothe material by stitching, wherein the Swedish sponge clothe material and the woven fabric material defined a flat geometric shape; and
a non-toxic coating on the woven fabric material.
